(19) United States
(12) Patent Application Publication
(10) Pub. No.: US 2012/0066136 A1
(43) Pub. Date: Mar. 15, 2012

(54) SYSTEMS AND METHODS FOR PROVIDING COMPUTER-IMPLEMENTED BUDGETING OUTPUT

(75) Inventor: Douglas C. Calahan, Atlanta, GA (US)

(73) Assignee: ARGO SYSTEMS, INC., Atlanta, GA (US)

(21) Appl. No.: 12/881,991

(22) Filed: Sep. 14, 2010

(51) Int. Cl. G06Q 50/00; G06Q 10/00

(52) U.S. Cl. 705/311

(57) ABSTRACT

The present disclosure describes various embodiments of budgeting systems and methods for providing a computer-implemented budgeting output relating to projected royalty payments due under contracts between a media system operator and content owners. The embodiments include one or more royalty calculation rules modules (RCRMs), each RCRM including predetermined rules for determining royalty payments. An RCRM user interface configured accepts entry of inputs related to contract data and the predetermined rules. The RCRMs are capable of associating input data and predetermined rules with contracts or content owners and storing the associated data and rules. One or more user interfaces can receive and process inputs related to one or more of budgeting periods, media content, content providers, or subscribers. Further, the embodiments include a database for storing data including the RCRMs in association with data corresponding to a predetermined budgeting period. A calculation engine can access the RCRMs and utilizes the stored associated data and rules to determine a projected budget for a predetermined budgeting period. Finally, a budget output module generates the projected budget in a predetermined output format to the budget manager personnel via the budgeting system.

### TECHNICAL FIELD

The present application relates generally to media distribution and management systems, and more particularly to methods and systems for generating budget outputs, taking into account various variables and rules, and performing complex computations.

### BACKGROUND

Generally, media operators negotiate royalty contracts with content owners to gain the rights for distributing content to subscribers. Media (also referred to as ‘content’) operators can include local network television station affiliates, cable television providers (COMCAST®, Time-Warner®, Charter®), telcos, and terrestrial or satellite TV providers (DirecTV, Dish Network). These royalty contracts are often complex, having several calculable provisions, each different for each content provider, such as the royalty rate to be paid per subscriber to the content owner. Moreover, the royalty contracts include complex payment terms based on factors typically dictated by the content providers such as MTV®, Fox® network, CNN®, and other such providers. Further, each operator may negotiate hundreds of contracts with different content owners and make royalty payments to the content owners based on these contracts, sometimes on a monthly basis.

These contractual terms vary widely and depend upon several variables, different for each content provider. The media operators prepare forecasts (budgets) of programming royalties payable to the content providers over a period of time. One way of calculating royalties is to determine the number of customers (subscribers) that subscribe to each channel package (called ‘tiers’), and then pay the content providers based on the number of subscribers that opt for the package in a given month.

Such budget forecasting includes highly complex and tedious calculations that must be performed for each content owner. Moreover, if contract terms change, the whole process must be repeated, which can take substantial time. Therefore, a long-felt but unresolved need exists for a system or method that performs the complex calculations based on the contract provisions and subscriber information and provides a budgeting output for each content provider, in an accurate, cost-effective and efficient manner.

### BRIEF SUMMARY

Briefly described, and according to one embodiment, the present disclosure describes a budgeting system for providing a computer-implemented budgeting output relating to projected royalty payments due under contracts between a media system operator and content owners. The system includes one or more royalty calculation rules modules (RCRMs), each RCRM including predetermined rules for determining royalty payments. An RCRM user interface accepts entry of inputs related to contract data and the predetermined rules. The RCRMs are capable of associating input data and predetermined rules with contracts or content owners and storing the associated data and rules. One or more user interfaces can receive and process inputs related to one or more of budgeting periods, media content, content providers, or subscribers. Further, the system includes a database for storing data including the RCRMs in association with data corresponding to a predetermined budgeting period. A calculation engine can access the RCRMs and utilizes the stored associated data and rules to determine a projected budget for a predetermined budgeting period. Finally, a budget output module generates the projected budget in a predetermined output format to the budget manager personnel via the budgeting system.

Another embodiment includes a method for providing a computer-implemented budgeting output relating to projected royalty payments due under contracts between a media system operator and content owners. The method provides one or more royalty calculation rules modules (RCRMs). Each RCRM includes one or more predetermined rules for determining royalty payments, association to one or more contract terms or content owners, and data related to contract terms or content owners. The method accepting data inputs into the RCRM through an RCRM user interface. Further, the method receives and processes inputs related to one or more of budgeting periods, media content, content providers, or subscribers through one or more user interface(s). The method then stores the RCRMs with the associated data and the received and processed inputs into a database. The RCRMs are accessed and the method utilizes the stored associated data and rules, along with the received and processes stored data, to determine a projected budget for a predetermined budgeting period. Finally, the method provides the projected budget in a predetermined output format to the budget manager personnel via the budgeting system.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment. The drawings are illustrative in nature and are not necessarily drawn to scale.

FIG. 1 illustrates an exemplary television network that includes a budgeting system for providing a computer-implemented budgeting output.

FIG. 2 illustrates a method for providing a computer-implemented budgeting output corresponding to projected royalty payments according to one of the embodiments of the present disclosure.

FIG. 3 illustrates another embodiment of a method for providing a computer-implemented budgeting output corresponding to projected royalty payments.

FIGS. 4A and 4B illustrate an exemplary embodiment of a method for updating the RCRMs for a contract.

FIG. 5 illustrates the workflow of a computer-implemented budgeting system designed in accordance with one of the embodiments of the present disclosure.

FIG. 6 illustrates an exemplary screen for a contract rate maintenance RCRM.

FIG. 7 shows an exemplary system maintenance screen.

FIG. 8 illustrates an exemplary template for entry of the number of subscribers for each tier at each system.

FIG. 9 shows an exemplary template for the entry of channel lineup changes.

FIG. 10 illustrates an exemplary database schema for the database of FIG. 1.

FIG. 11 depicts an exemplary budget summary report.

FIG. 12 provides an exemplary budget detail report.

FIG. 13 depicts an exemplary expense trend report.

FIG. 14 shows an exemplary subscriber trend report.

FIG. 15 displays an exemplary rate trend report.

### DETAILED DESCRIPTION

For promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. Limitations of scope should be determined in accordance with and as expressed in the claims.

### Overview

Briefly described, aspects of the claimed invention relate to computer-implemented systems and methods that manages complex contracts for media operators (e.g. cable TV operators, satellite TV operators) and media content owners (e.g. Fox® network, MTV®, Sci-Fi Channel®, ESPN®, HBO®, etc.) that charge certain fees (or royalties) for their content according to predetermined variables within the contracts. The various embodiments of the disclosure provide a budgeting tool that allows the operators to calculate their programming budgets, based on subscriber and channel lineup projections for a budget period. These budgets are required by the operators to assess the royalty payments they may need to make to the content owners for various combinations of channels, and channel alignments, and number of subscribers that are new or continuing subscribers, etc.

### Definitions

The following terms will be used throughout the present disclosure and are defined here for the purpose of clarity and convenience. These definitions, however, are not meant to be limiting to the scope of the disclosure, which is defined by the claims:

Subscriber: A user who pays for a service, such as receiving media content from an operator, also referred to as a ‘customer’.

Operator: Includes local network television stations affiliates, cable television providers, telcos, terrestrial, satellite TV providers, etc.

Content owner: Owners of media content, also referred to as ‘content providers’.

Tier: Collection of TV channels arranged or grouped in a predetermined manner, and sold by an operator as a group or collection to their customers. E.g. COMCAST® has a ‘Family Tier’ that comprises a collection of ‘family friendly’ TV channels that are often together in the channel lineup, and sold to customers as a unit. Customers typically purchase one or more “tiers” when they subscribe to a media provider, and are charged for the content based on the tiers they have selected from the operator. These ‘tiers’ have implications for royalty calculations to the content owners.

Lineup: The predetermined order in which a collection of TV channels are arranged or grouped and sold by an operator

Budget run: The steps which, when executed by a budgeting system in a certain order, result in a projected budget output.

Contract terms: The terms and provisions of a contract, to which all parties involved must comply, based on which the budget is calculated.

System: A facility for receiving TV signals for processing and distribution over TV network, also referred to as ‘end system’.

Division: An administrative authority for a group of systems.

Royalty calculation rules modules (RCRM): Applications that encapsulate royalty calculation rules and are applied in a certain order to compute a projected royalty to be paid to a content owner.

Budget period: The time period for which the budget is prepared and over which the budget remains valid.

Budget season: A certain portion of the year reserved for budget preparation.

Contract rates: Rates corresponding to media content, which are derived from contract terms.

Projection authority: Any of divisions or systems personnel who will prepare the projections relating to the number of subscribers and channel lineups during the budget season.

Embodiments of the present disclosure generally relate to aspects of budgeting methods and systems for providing a computer-implemented budgeting output relating to projected royalty payments due under contracts between a media operator and content owners. The various embodiments include one or more user interfaces and databases for supporting the generation of a projected budget. A projected budget may require generating a budget several times iteratively, involving updates, and feedback by a user. Each iteration is referred to as a budget run, and these iterations result in a projected budget which is employed for making royalty payments by the operators to the content owners.

### Exemplary System

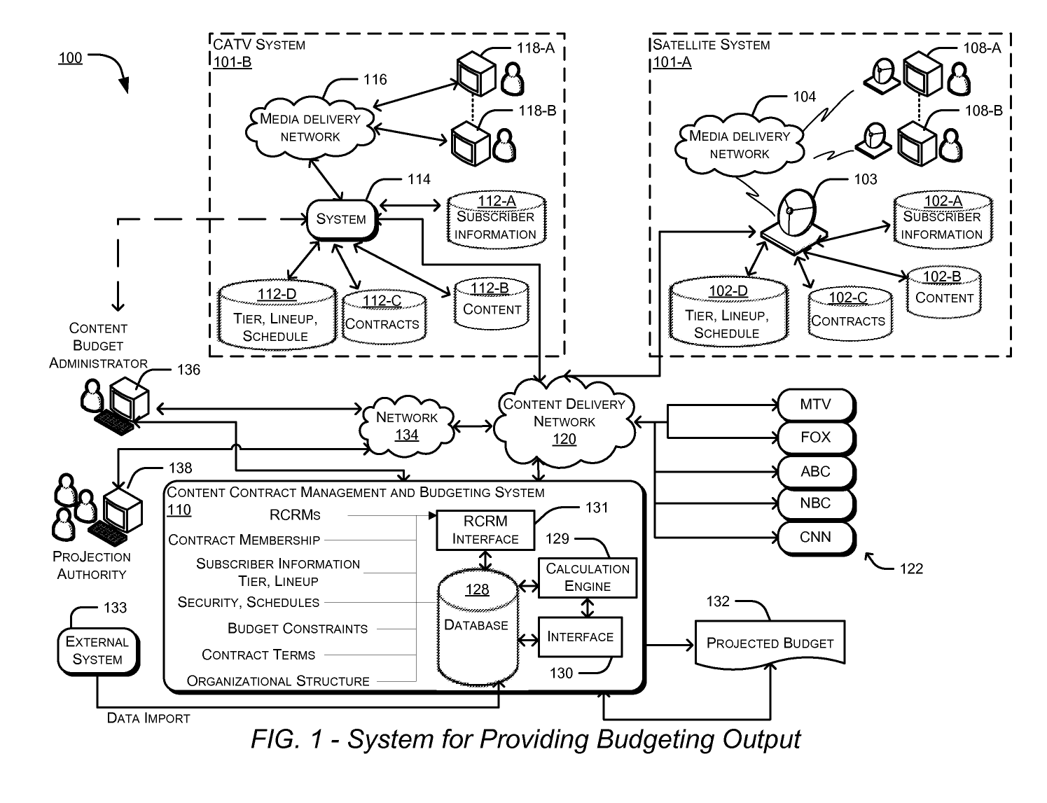

FIG. 1 illustrates an exemplary television network 100 that includes a budgeting system for providing a computer-implemented budgeting output. The television network 100 includes a satellite system 101-A having databases 102. Here, the databases 102 include, but are not limited to, a subscriber information database 102-A, a content database 102-B, a contracts database 102-C, and a tier, lineup, and schedule database 102-D. The databases 102 provide inputs to a system 103, which in turn interacts with a media delivery network 104. The media delivery network 104 is typically connected wirelessly with several individual subscribers including 108-A and 108-B that may have their own dish antennas and television sets for reception.

Similarly, the television network 100 includes a cable television (CATV) system 101-B. The CATV system 101-B includes its own databases 112 that include, but are not limited to, a subscriber information database 112-A, a content database 112-B, a contracts database 112-C, and a tier, lineup, and schedule database 112-D. The databases 112 provide inputs to a system 114, which acts as an interface between the databases 112 and a media delivery network 116. The media delivery network 116 is typically connected though coaxial cables to several individual subscribers including 118-A and 118-B, that may have their own television sets for media reception and viewing.

In FIG. 1, both operators—the satellite system 101-A and the CATV system 101-B—are shown connected to a content delivery network 120. It will be understood by those skilled in the art that several other operators may additionally be connected to the content delivery network 120, such that content may be delivered to subscribers through any operator such as telcos and terrestrial networks.

The content delivery network 120 receives content from content owners 122, such as MTV®, Fox® network, CNN®, ABC®, NBC®, etc. The content delivery network 120 is further connected to a content contract management and budgeting system 110 (referred to as budgeting system 110 hereinafter).

The budgeting system 110 includes a database 128, which carries information related to various aspects of budgeting including tier and lineup information, RCRMs, contract membership information, subscriber information, security and scheduling information, budget constraints, contract terms, and organizational structure. Some of this information, such as contracts and contract terms, may be received directly from the content owners 122.

A calculation engine 129 utilizes data provided as input into one or more interfaces, referred hereinafter as interface 130, and the database 128 and prepares a budget that is displayed to the operator's personnel. The interface 130 may, in certain embodiments, facilitate various functions, such as setup and management of tiers, setup and management of channel lineups, setup and management of subscribers, setup and management of organizational structure, setup and management of security, setup and management of budget constraints and runs, and analytical reporting. An RCRM interface 131, which is linked to the database 128, facilitates setup and management of contract terms and RCRMs. The RCRM interface 131 can accept data related to the fields in an RCRM, along with information related to the rules within the RCRM. A projected budget 132, generated by the calculation engine 129 and displayed by the interface 130, may then be used to assist the operator with its business planning, such as planning for subscriber promotions, negotiating or renegotiating contracts with content owners, exploring “what-if” scenarios with different channel lineups and tiers, subscriber growth rates, etc. In some implementations, the projected budget 132 can be fed back to the budgeting system 110 along with other inputs for processing and subsequent generation of a revised budget.

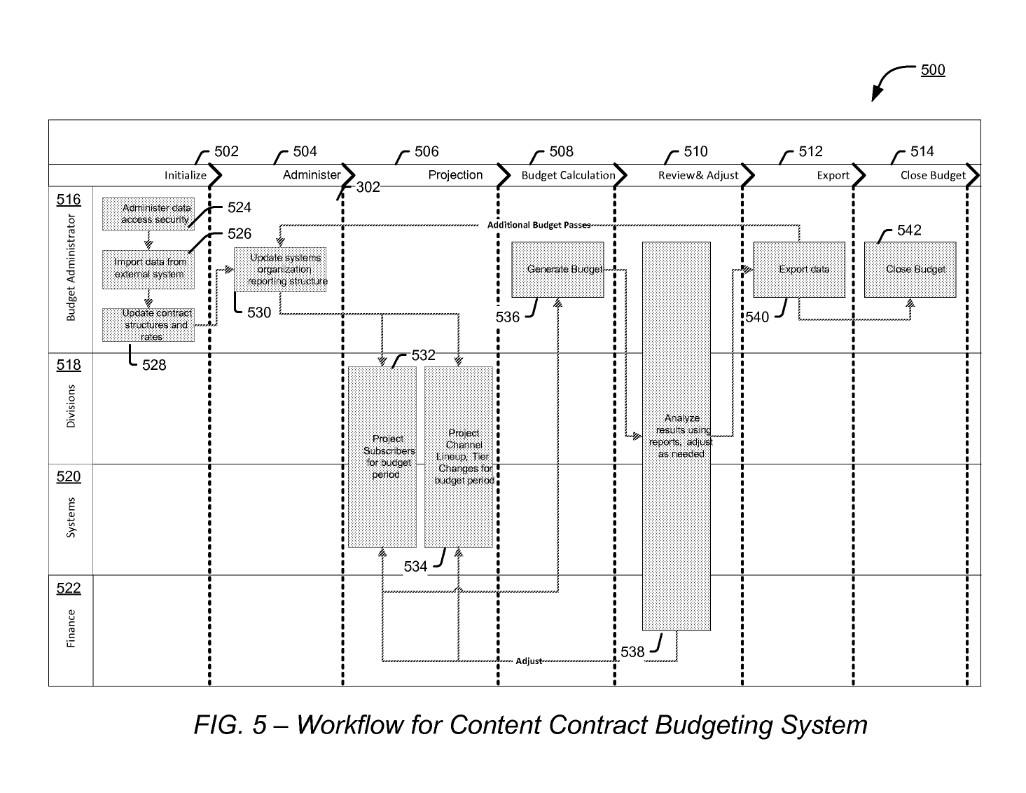

In some implementations, the database 128 is connected to an external system 133, e.g., a billing system, from which it imports data applied for preparing the projected budget 132. The external system 133 may be utilized for importing any type of information, e.g., contract terms, tier or lineup information etc. This information is stored in the budgeting system 110 and can be edited by a user, as will be explained in more detail in relation with FIG. 5.

The content delivery network 120 is further associated, through a network 134, with a content budget administrator 136 and a projection authority 138. The administrator 136 interacts with the various parts of the television network 100, such as the network 134 and the budgeting system 110, to view schedules and lineups, enter and manage contract terms with the various content owners 122, arrange or rearrange the lineups and tiers for business and promotional purposes, import actual or projected subscriber data (i.e. number of subscribers expected in various planning scenarios), input budgeting time periods, and cause the RCRMs or the calculation engine 129 to be applied during a run of the budget.

### Exemplary Methods

The following sections describe exemplary methods for carrying out one or more embodiments of the present disclosure. The methodology described herein is generally intended to describe various features and functionality of various system components described previously. The order in which the method steps are described is not intended to be construed as a limitation and any number of the described method blocks can be combined in any order to implement the method, or an alternate method. Additionally, individual blocks may be deleted from the methods without departing from the spirit and scope of the subject matter described herein. Furthermore, the method can be implemented in any suitable hardware, software, firmware, or combination thereof

In particular, the disclosed methods execute in the television network 100 to allow the various contract terms to be entered as rules (or RCRMs) that can be applied to the various variables such as tiers, subscriber count, proposed channel lineups and organization, etc. The contract terms are embodied as selectable RCRMs that can be applied to the variables to compute royalty payments and schedules. Once the RCRMs are entered, personnel for the media operator provide boundaries for a time period for budgeting, allowing a projection or simulation of proposed royalty payments to particular content owners, given particular estimations of subscriber numbers, channel offering, tiers, and the other variables.

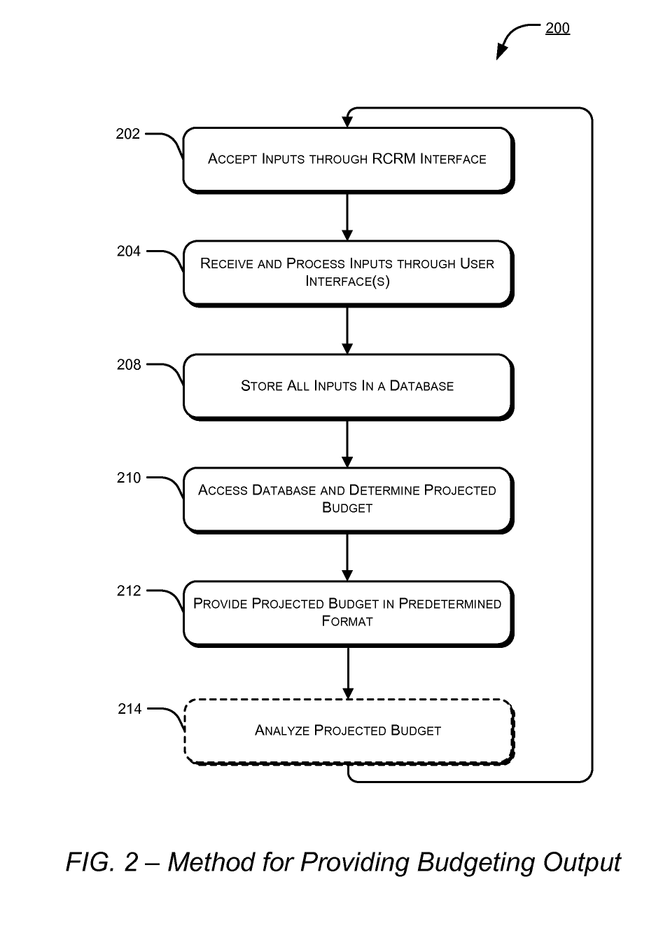

FIG. 2 illustrates a method 200 for providing computer-implemented budgeting output relating to projected royalty payments due under contracts between a media operator and content owners, according to one of the embodiments of the present disclosure. The projected royalty payments, determined in accordance with contract terms provided in one or more pre-negotiated contracts, are made by a media operator to a content owner. The method 200 is utilized by budgeting manager personnel associated with the media operator via the budgeting system 110, the interface 130, and the RCRM interface 131.

The method 200 provides one or more RCRMs, each RCRM including predetermined rules for determining royalty payments, association to one or more contract terms or content owners, and may also have data related to contract terms or content owners. The RCRM interface 131 accepts data inputs into an RCRM at step 202. The budgeting system 110 can further receive and process inputs related to budgeting periods, media content, content providers, or subscribers through the interface 130 at step 204. The database 128 stores the RCRMs with the associated data and the received and processed inputs at step 208.

At step 210, the method 200 accesses the RCRMs related to a contract and utilizing the stored associated data and rules, along with the received and processed stored data, determines, using the calculation engine 129, the projected budget 132 for a predetermined budgeting period. Finally, at step 212, the interface 130 provides the projected budget 132 in a predetermined output format to the budget manager personnel.

In one implementation, the projected budget 132 can be analyzed at step 214 (shown in dotted lines). If the budget needs revision or if certain updates are required (for example, changes in contract terms or number of subscribers, or tier and lineup information), the steps 202 to 212 maybe repeated until an acceptable budget is generated by the budgeting system 110.

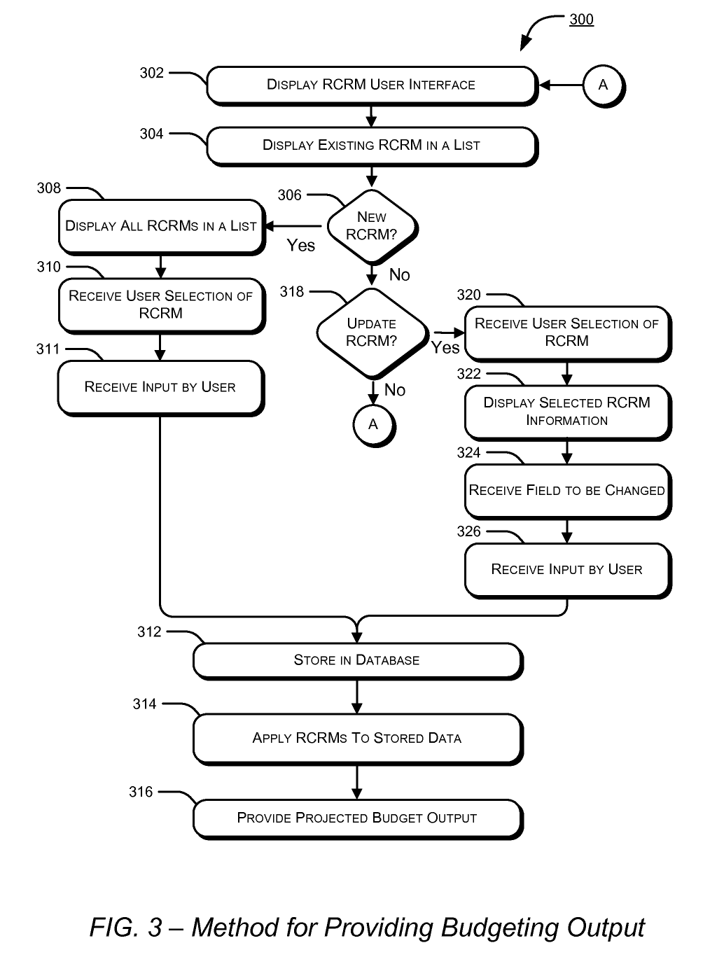

FIG. 3 illustrates another embodiment of a method 300 for providing a computer-implemented budgeting output corresponding to projected royalty payments. The present embodiment focuses on the RCRMs and their selection. Consider that a contract and a time period to be viewed has been selected. At step 302, the method 300 displays the RCRM interface 131 to the user and displays the RCRMs that are applicable to the contract within the time period in a list at step 304. If it is determined at step 306 that a new RCRM is to be added to the list, the method 300 proceeds to step 308, where it displays all existing RCRMs in a list. Addition of a new RCRM may represent a contract term in the contract. For example, a new term may dictate that for each subscriber to a particular tier, the operator must pay the content owner 5 cents. Consequently, the RCRM being added may be one that calculates the total amount payable to the content owners based on the number of subscribers. At step 310, the method 300 receives user's selection of an RCRM and further, receives input related to the selected RCRM from the user at step 311. The input may be values for variables or fields within the RCRM. In terms of the earlier example, the user may enter the number of subscribers to the tier and the amount payable per subscriber, which was specified as 5 cents. The received user input is stored in an appropriate database at step 312. Subsequently, the RCRMs for the contract are applied to the data stored in the database 128 at step 314, and the method 300 generates a projected budget 132 as output at step 316.

If at step 306, it is determined that no new RCRM is required, the method 300 proceeds to step 318, where it is determined whether an RCRM on the list needs to be updated. If it is determined that an RCRM needs to be updated, the method 300 receives the selection of an RCRM on the list from the user at step 320 and displays related information on the RCRM interface 131 at step 322. For example, a contract terms may need to be updated to change the royalty rate from 3 cents per subscriber to 5 cents per subscriber. The user then specifies the field in the RCRM to be changed, at step 324, and the method 300 receives user input specifying the change, at step 326. The user inputs are stored in the database 128 at step 312, and the method 300 proceeds to steps 314 and 316, as already discussed above. Alternatively, if at step 318, the method 300 determines that no RCRM update is necessary, the method 300 returns to step 302, as shown by connector A.

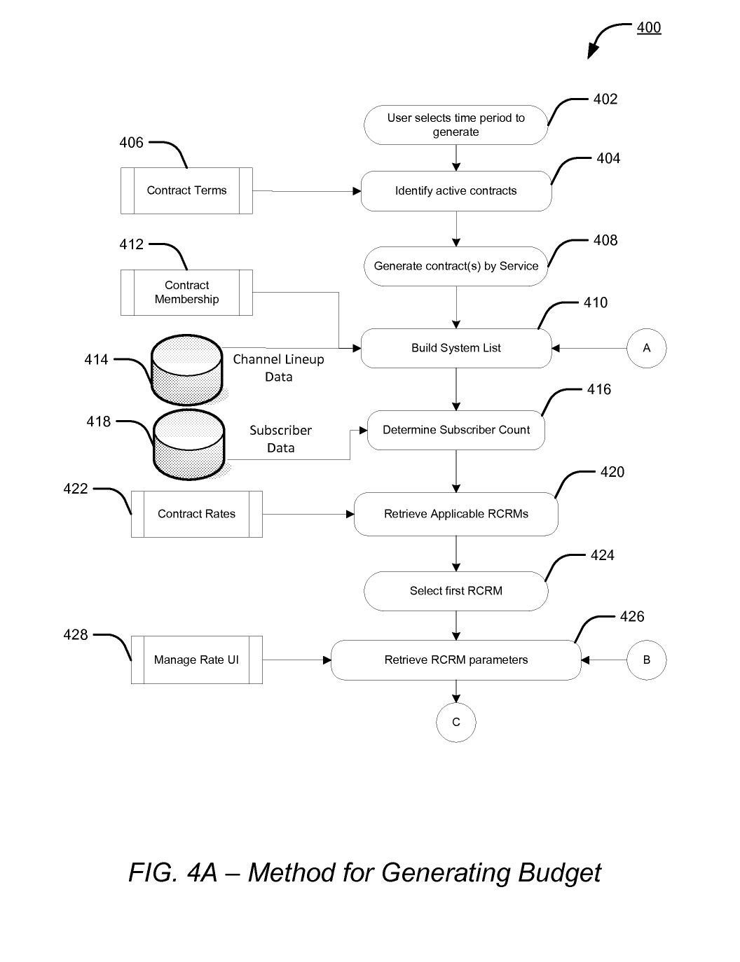

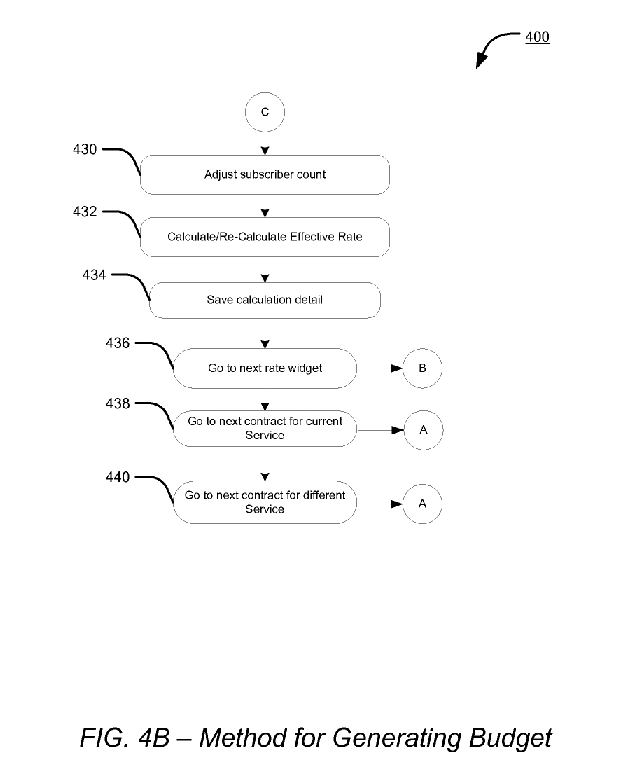

FIGS. 4A and 4B illustrate an exemplary embodiment of a method 400 for generating the budget for a contract. At step 402, a user of the budgeting system 110 selects a time period for which the user wishes to generate the budget or the budget period. The budgeting system 110 identifies the active contracts at step 404 by evaluating the contract terms 406 of various contracts. At step 408, the budgeting system 110 generates the active contracts for a particular content offering (channel or service). At step 410, a system list is built for each contract based on contract membership information 412 and channel lineup data from the channel lineup database 414. Then the budgeting system 110 determines subscriber count at step 416 from the subscriber database 418 for all the systems in the system list.

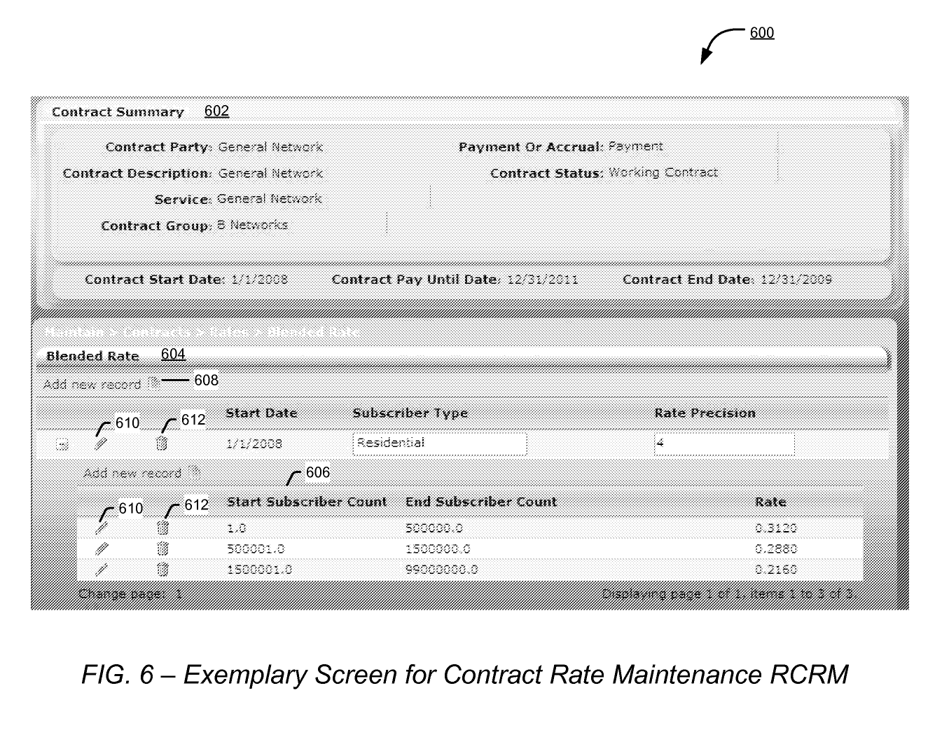

The budgeting system 110 retrieves applicable RCRMs for each contract within a service at step 420 based on the contract rates 422. The first of the retrieved RCRM is selected at step 424 and related RCRM parameters may be received from a user through a rate user interface 428. This will be explained in more detail with reference to FIG. 6. Step 426 is followed by step 430 through connector C, where subscriber count is adjusted based on the inputs from the rate user interface 428, if required. Step 432 calculates the effective rate. This may be a re-calculation of an effective rate determined earlier by another RCRM. At step 434, the budgeting system 110 saves the calculation detail and proceeds to the next RCRM at step 436. Here, the method 400 returns to step 426, as shown by connector B. In alternate embodiments, the method 400 can include adding a RCRM by selection from an RCRM list. Data values may be inserted into the RCRM based on the contract term represented by the RCRM. In another embodiment, a copy of an RCRM in the list may be generated and data values may be changed within the RCRM copy to represent a contract term.

Once all the RCRMs for a contract have been reviewed, and it is ensured that all required contract terms are accurately represented as RCRMs, the budgeting system 110 proceeds to the next contract within the service, at step 438, through connector A. Once all contracts have been reviewed within a service, the budgeting system 110 proceeds to the next service at step 440, through connector A.

Thus, the budgeting system 110 allows management of RCRMs based on variables such as the dates of effectiveness of a content owner's contract, identification of the content owner, status of a contract, subscriber counts and the rates associated therewith, etc.

### Budgeting System Workflow

FIG. 5 illustrates the workflow 500 of a computer-implemented budgeting system designed in accordance with one of the embodiments of the present disclosure. User groups appear as rows along the left side of the FIG. 5, while the various phases of budget formulation appear as columns along the top. In the present embodiment, consider the budgeting system 110 as being a standalone application to facilitate the formulation of a yearly budget for television operators providing content obtained from content owners to subscribers. The subscribers may use televisions for receiving the various television channels. Moreover, the subscribers may have the ability to choose predefined tiers they want to receive. The budget formulation includes the high-level tasks listed below:

Initialization—A once-per-budget-season setup of the budgeting system 110. This step may include data imported from the external system 133, such as a billing system. This information may include contracts with content owners and related contract terms and rates, tier and lineup information, system information, organizational structure, budget period, subscriber information, etc.

Iterative Budget Development—Multiple budget runs may occur over the course of the budget season. Each run may begin, for example, with the input of budgeting subscribers and channel lineup changes for the budget season in the budgeting system 110. When complete, the administrator 136 will instruct the budgeting system 110 to generate the budget in detail, taking into account the input information and contract terms. Users may utilize the budgeting system's 110 reporting functionality to review the budget detail and make adjustments, as necessary. When no further changes are necessary, this information may be exported from the budgeting system 110 for further processing, review, or storage. Again, based on the exported data analysis, further changes may be required. This entire process may be repeated multiple times during the budgeting season, until an appropriate budget has been prepared.

Close Budget—Once the budget is finalized, the budget season will be closed in the budgeting system 110. Further changes may not be allowed to the budget from this point forward.

As already stated, the various phases of budget formulation appear as columns along the top and include the following seven exemplary phases, which will be discussed in more detail further on—initialize 502, administer 504, field localization 506, budget calculation 508, review and adjust 510, export 512, and close budget 514. In addition, user groups including—budget administrator 516, divisions 518, systems 520, and finance 522—appear as rows along the left side of the FIG. 5.

### Initialize 502

Formulation of a yearly budget begins as the budgeting system 110 is initialized by the budget administrator 516. In the present embodiment, the initialization phase is carried out entirely by the budget administrator 516. In one implementation, the initialization process is performed once yearly and includes importing data from the external system 133, such as a billing system, into the budgeting system 110. Data security may also be set up at this time. Contract terms including structures and rates for the budget period are then provided to the budgeting system 110 as input.

At block 524, the workflow 500 administers data access security. Overall, the budgeting system 110 access may rely on a directory service, such as Microsoft® Active Directory. In addition, the budgeting system 110 may provide the ability to restrict data update privileges at various levels such as organization, division, or even individual user. For example, an organization may only be allowed to update its own data and will have limited or no access to the data belonging to other organizations.

Then at block 526, data may be imported from the external system 133. The data can include contracts, systems, organizational structure, channel lineups, tiers, and subscriber information and may further be accessible by month.

Next, at block 528, the budget administrator 516 may update contract terms such as structures and rates in order to update those contracts to reflect the terms/rates anticipated for the budget period. The budgeting system 110 may provide a user interface for performing this task.

### Administer 504

Immediately following initialization and on an ongoing basis once the budget preparation begins, the budget administrator 516 may need to perform tasks that affect the overall budget preparation. This includes maintaining key data elements such as organizational structure and system 520 state. Functional elements of block 530 of this phase may include the following:

Update systems 520—Allows the budget administrator 516 to log system 520 state such as splits, merges, purchases, or sales occurring over the course of the budget period. These changes can be date-aware, such that the budgeting system 110 adjusts its calculations appropriately. For example, when a system 520 split takes place, the budgeting system 110 can create a new budget system entry and copy channel lineup from the original system entry; in case of system 520 purchase, the budgeting system 110 can create a new budget system entry and a user may manually enter channel lineup information.

Update organizations—Allows the budget administrator 516 to log upcoming organizational/structural changes, which may reflect the changes in the system 520 or division 518 status. These changes may be date-aware, so that the budgeting system 110 adjusts its calculations appropriately.

Audit trail—The budgeting system 110 may track any changes made through a user interface in a separate history database for future audit purposes. This can include time stamping the date/time when the change was made, documenting the user ID of the user making the change, and noting the before/after values.

### Projection 506

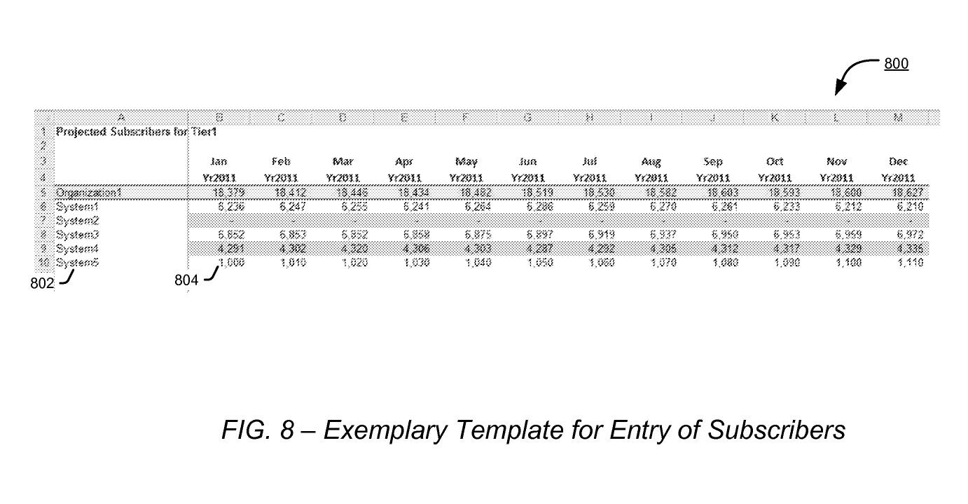

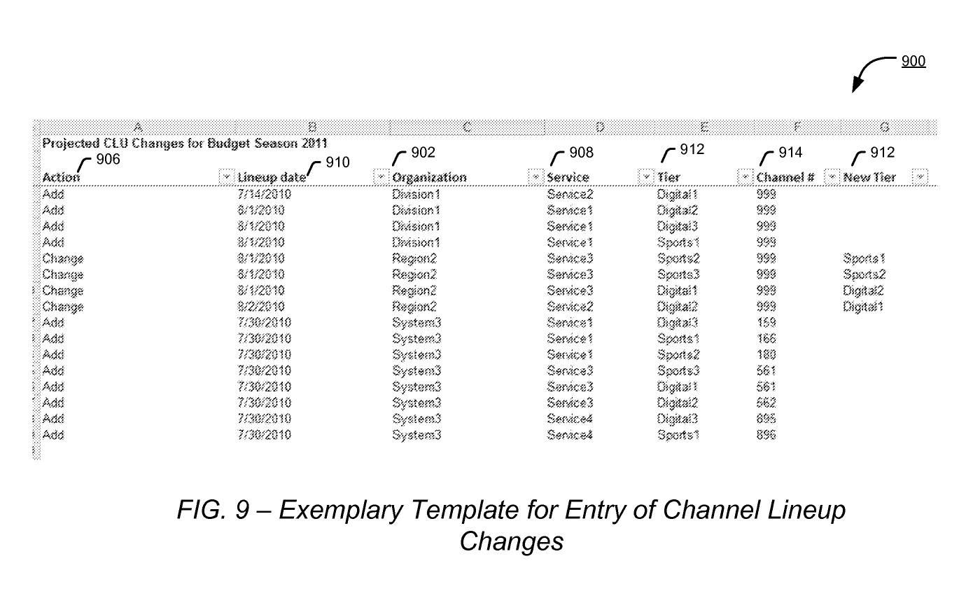

The budgeting system 110 may provide an automated way for systems 520 and divisions 518 to budget tier, channel lineup, and subscriber changes over the budget period. For example, each organization may utilize a specially designed Excel template to capture the data; this template will then be imported into the budgeting system 110. Such templates are described in more detail with relation to FIGS. 8 and 9. Data validation mechanisms may be employed to ensure that this data is accurate. From a security perspective, data update capabilities can be restricted by organization, allowing users to update data for which they have explicitly assigned access rights. Additional information on the functional elements of this phase is as follows:

Project subscribers for budget period at block 532—Allows users (which would include systems 520 and divisions 518 personnel here) to enter or modify subscribers by tier at system 520 level for all months of the budget period. Data entry may be accomplished through use of a user interface. As part of the data entry process, the budgeting system 110 may ensure data integrity for certain data elements. Some exemplary data elements are described below:

i. Systems 520—only active systems 520 associated with the user's organization will be available.

ii. Tiers—only active tiers associated with the user's organization will be shown.

iii. Subscriber Count—values must be valid (positive, numeric), present for all months of the budget period.

Project Channel Lineup, Tier Changes for budget period at block 534—Allows users to log changes to the channel lineup, including mandatory and elective service launches, by system 520 for all months of the budget period. As part of the data entry process, the budgeting system 110 may ensure data integrity around the following elements:

i. Systems 520—only active systems 520 associated with the user's organization will be available.

ii. Reason for Change—only valid predefined values allowed.

iii. Network (Services)—only active services.

iv. Date of Change—valid dates during budget period.

v. ‘From’ and ‘To’ Tiers—May be related to Reason for Change, only valid tiers allowed.

vi. ‘From’ and ‘To’ Channel Numbers—may be related to Reason for Change. The budgeting system 110 may not allow two services on same channel number or same tier.

Lock out—The budgeting system 110 can allow the divisions 518 to ‘lock out’ lower organizational levels (e.g. the systems 520 that report to that division 518) to prevent further changes by the systems 520 and to allow the divisions 518 to change the budget themselves.

### Budget Calculation 508

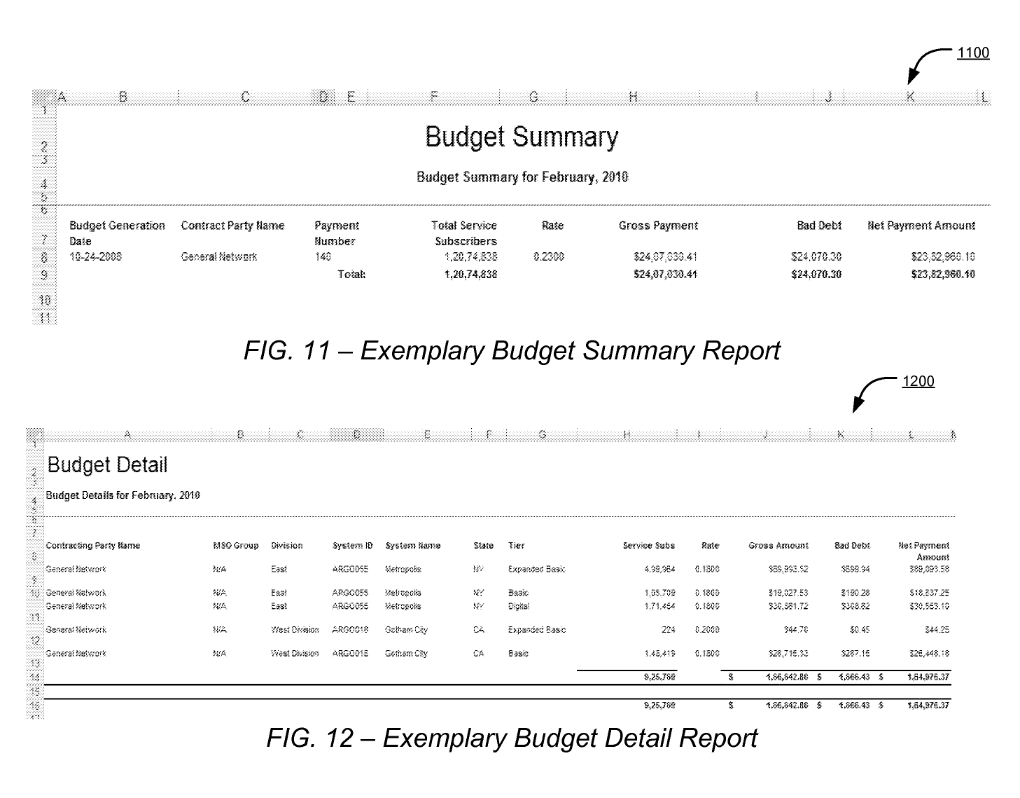

The budgeting system 110 may allow the budget administrator 516 to generate the budget at block 536, using the latest contract terms/rates, subscriber and channel lineup forecasts, organizational structure, and other key parameters for a given period of time. The budget administrator 516 may run the budget for all months at once, or just for selected month(s). Full expense detail may be generated for all of the months selected, as will be explained in more detail with reference to FIGS. 11-13. The budget administrator 516 can initiate budget runs on an ad-hoc basis and budgets may be re-run multiple times. In one implementation, a budget run will require between 8-12 hours to complete.

### Review and Adjust 510

At block 538, the budgeting system 110 may provide a number of reports to assist the budget analysis by the budget administrator 516, divisions 518, systems 520, and finance 522.] Further, at this phase, the reports are analyzed and adjustments may be made at blocks 532 and 534. A summary of the various types of exemplary reports is provided below and some of these will be described in more detail in relation with FIGS. 11-15:

Budget Summary—Monthly report that provides summary expense information by content owner.

Budget Detail—Monthly report that provides detailed expense information by content owner, organization, or tier/tier group.

Subscriber Trend—12 month budget period report used by the divisions 518 to review expense with their systems 520. This may be available by organization, content owner, or tier/tier group.

Rate Trend—12 month budget period report used by the divisions 518 to review expense with their systems 520. This may be available by organization, content owner, or tier/tier group.

Expense Trend—12 month budget period report used by the divisions 518 to review expense with their systems 520 and by finance 522 for aggregate. This may be available by organization, content owner, or tier/tier group.

Free Period End—Shows which services will/will not be free by month, by organization/system 520, given the service's launch date and the free period provisions associated with the contract.

### Export 512

The budgeting system 110 can provide capabilities for exporting data for use in external systems at block 540. The budgeting system 110 may allow the budget administrator 516 functionalities such as internal budget versioning and external archiving of different budget versions. The budgeting system 110 may provide the following types of reports to facilitate the export of data—Expense Report, Subscribers by Tier Report, and Subscribers by Tier by Channel Report. After exporting data, the workflow 500 may return to block 530 for further updates. Such iteration within the workflow 500 is referred to as a budget run. The budget may be run several times during the budget season, until an acceptable budget is projected.

### Close Budget 514

Once the budget is accepted, the budget administrator 516 can officially close the budget season in the budgeting system 110 at block 542. No further changes to the budget will be allowed.

### Exemplary Budgeting System Screens

FIG. 6 illustrates an exemplary screen 600 for a contract rate maintenance RCRM. The screen 600 provides a contract summary 602 and a rate section 604, which shows the start date of the contract, subscriber type, and the decimal precision of the rate. It is obvious that these fields may vary depending on system requirement without departing from the scope of this disclosure.

Further, the rate section 604 has a sub-section 606 that shows different rates for different subscriber brackets. Here, the data represents the following—for the first 500,000 subscribers, the royalty rate will be 0.3120 cents and will reduce to 0.2880 cents for the next 1,000,000 subscribers. The royalty rate will further fall to 0.2160 cents if the number of subscribers exceeds 1,500,000 subscribers until the number of subscribers reaches 99 million. The ‘Add new record’ tabs 608 allow a user to add different types of users or number of subscriber brackets. Further, icons 610 and 612 allow a user to edit and delete different fields, respectively.

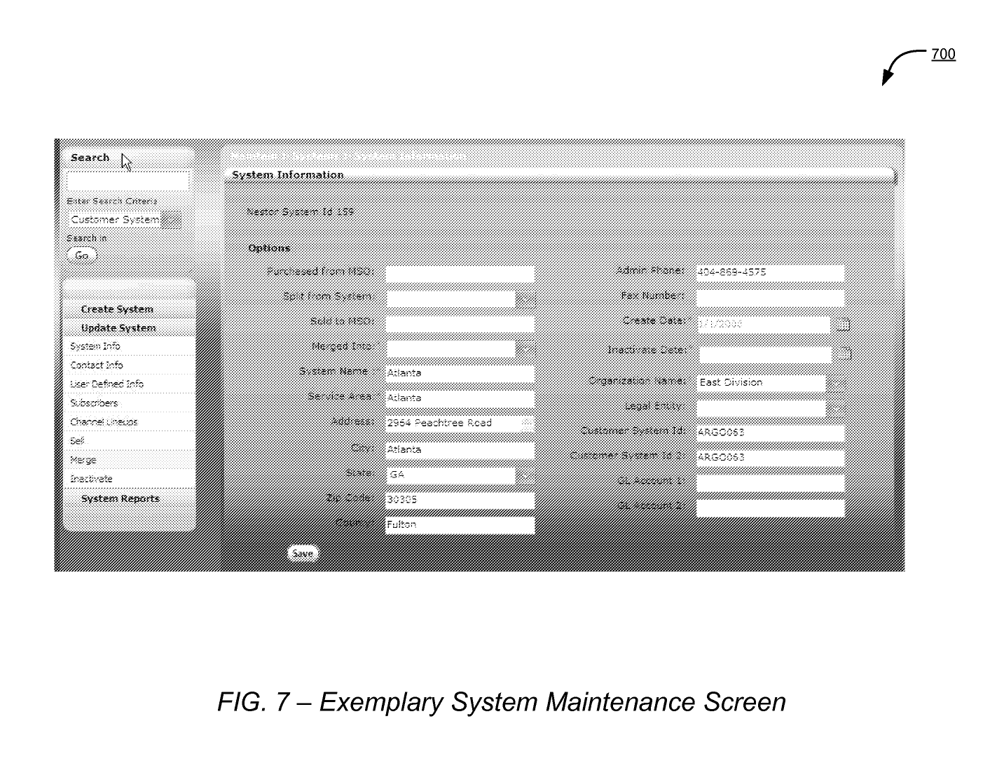

FIG. 7 shows an exemplary system maintenance screen 700 accessible to the budget administrator 516 in the administer 504 phase in the workflow 500. Various fields for a system 520 may be edited through this system maintenance screen 700, such as system 520 name, contact information, organization, and system 520 splits and merges. The left hand menu also shows tabs allowing updates to subscriber and channel lineup information for a system 520 and also allows creation of a new system 520 within the budgeting system 110.

### Exemplary Templates for Budgeting System Inputs

FIG. 8 illustrates an exemplary template 800 for entry of the number of subscribers for each tier at each system. In the template 800, 802 System 1 is an exemplary system, for which the number of subscribers can be entered in cell 804 for the budget period. Such information related to the number of subscribers may be entered into the budgeting system 110 through an upload of the template 800.

FIG. 9 shows an exemplary template 900 for the entry of channel lineup changes. The template 900 includes a system name 902 field. Reason 906 specifies the type of channel lineup change—for example, whether the channel is being added, dropped, or repositioned. The template 800 also includes a content owner 908 field, specifying the content owner (service) to which the channel corresponds. Next, effective date 910 field conveys the date from which the channel lineup change is effective. The template 900 also includes a tier 912 field that shows from which tier to which tier the channel is moved. The template 900 also includes a channel number 914 field, similar to the tier 912 field, indicating ‘from’ and ‘to’ information for channel number changes.

### Exemplary Database Schema

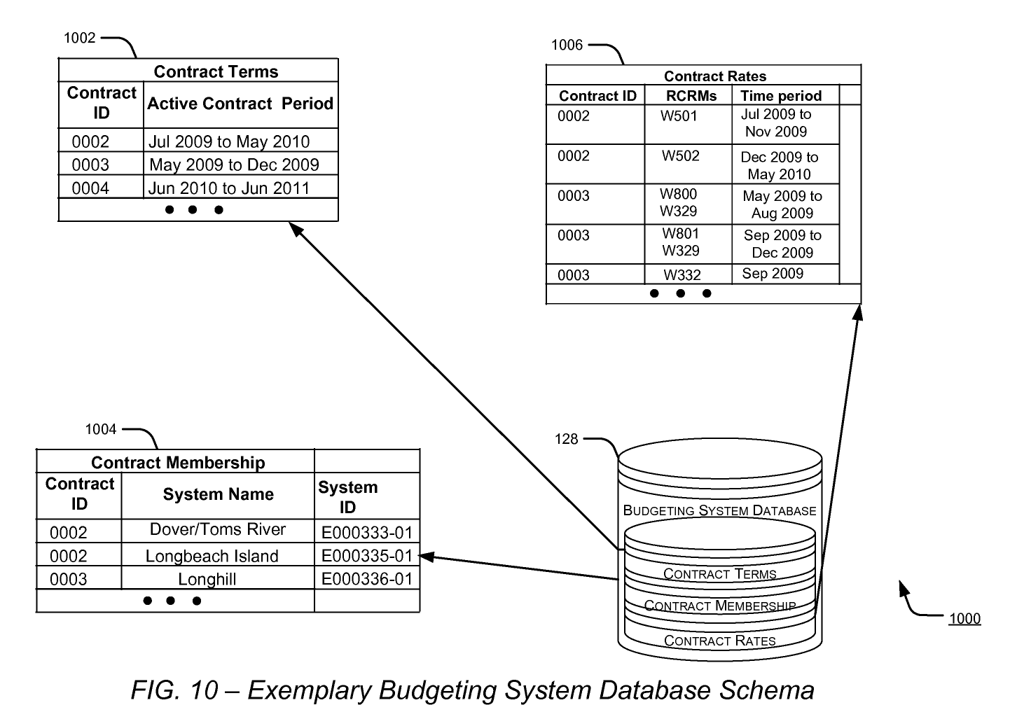

FIG. 10 illustrates an exemplary database schema 1000 for the database 128, depicting sub-databases for contract terms 1002, contract membership 1004, and contract rates 1006. It should be noted that as shown in FIG. 1, the database 128 may include several other sub-databases, although only three have been shown here.

Contract terms 1002 information includes contract IDs along with the corresponding active contract period, over which the contract is valid. Contract membership 1004 information includes system name and ID information for each contract ID. Contract rates 1006 information includes RCRMs for each contract ID and the time period over which the contract term and the corresponding RCRM is valid. Similar database schemas can be designed for subscriber, tier, lineup information, schedules, budget constraints, organizational structure, etc.

### Exemplary Reports

The budgeting system 110 provides a number of reports to assist in budget analysis, as already discussed on relation with FIG. 5. The reports may be exported in a variety of formats, including PDF and Microsoft Excel.

FIG. 11 depicts an exemplary budget summary report 1100, which provides a budget for the content owner ‘General network’ for the month of February 2010. Similar reports with varying template structures may be generated based on the user's requirement, such as, but no limited to, providing a report for multiple months, multiple content owners, or with varying rates for different subscriber brackets.

FIG. 12 provides an exemplary budget detail report 1200, including more detail than the budget summary report 1100, including detail on division, system ID and corresponding subscriber and rate information, tiers etc. As explained in relation with FIG. 11, the fields and other details may vary without departing from the scope or the purpose of the present disclosure.

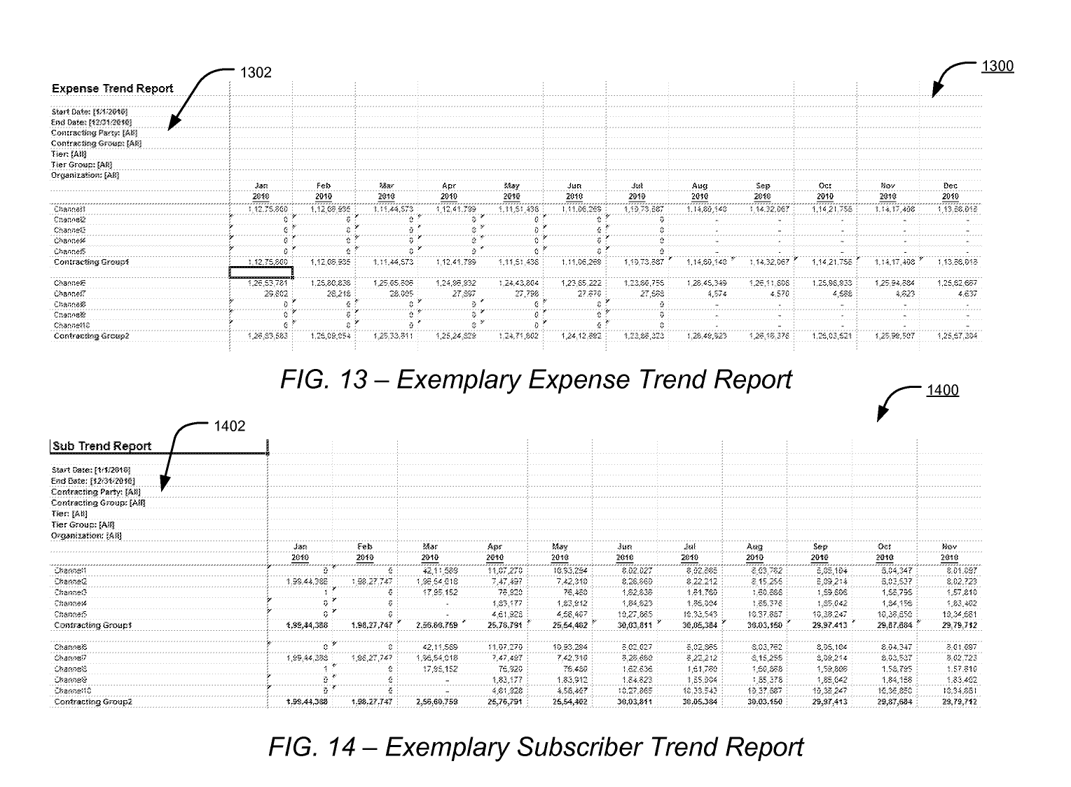

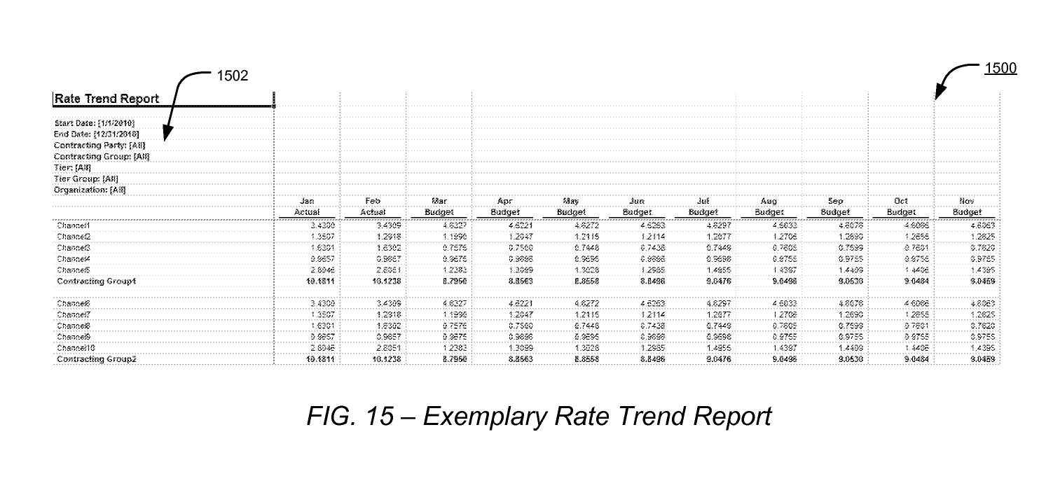

FIG. 13 depicts an exemplary expense trend report 1300, which provides the variation in expense trend over a period of time for each channel within each content owner network. Section 1302 shows the various criteria based on which the expense trend report 1300 may be filtered, such as start date, end date, tier, organization, contract information etc. It will be apparent to those skilled in the art that several other criteria may be used for generating the report. FIG. 14 shows an exemplary subscriber trend report 1400 providing variation in the number of subscribers for each channel within a content owner network over a period of time. Similar to FIG. 13, section 1402 shows the various criteria based on which the subscriber trend report 1400 may be filtered. Naturally, other criteria are also possible. FIG. 15 displays an exemplary rate trend report 1500 showing the rate variation (in cents) for each channel within a content owner network over a period of time. Similar to FIG. 13, section 1502 shows the various criteria based on which the rate trend report 1500 may be filtered. Naturally, the several other criteria may be utilized while generating the rate trend report 1500.

Systems and methods disclosed herein may be implemented in digital electronic circuitry, in computer hardware, firmware, software, or in combinations of them. Apparatus of the claimed invention can be implemented in a computer program product tangibly embodied in a machine-readable storage device for execution by a programmable processor. Method steps according to the claimed invention can be performed by a programmable processor executing a program of instructions to perform functions of the claimed invention by operating based on input data, and by generating output data. The claimed invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories. Storage devices suitable for tangibly embodying computer program instructions and data include forms of non-volatile memory, including by way of example, semiconductor memory devices, such as EPROM, EEPROM, and flash memory devices; magnetic disks such as internal hard disks and removable disks; magneto-optical disks; and Compact Disk. Any of the foregoing can be supplemented by or incorporated in ASICs (application-specific integrated circuits).

The specification has described a system and method suitable for providing real-time dynamic pricing information for products. The foregoing description of the exemplary embodiments has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the systems and their practical application to enable others skilled in the art to utilize the systems and various embodiments and with various modifications as are suited to the particular use contemplated. Alternative embodiments will become apparent to those skilled in the art to which the present disclosure pertains without departing from their spirit and scope. Accordingly, the scope of the present inventions is defined by the appended claims rather than the foregoing description and the exemplary embodiments described therein.

We claim:

1. A budgeting system for providing a computer-implemented budgeting output relating to projected royalty payments due under contracts between a media system operator and content owners, comprising:
one or more royalty calculation rules modules (RCRMs), each RCRM including one or more predetermined rules for determining royalty payments;
an RCRM user interface configured to accept entry of inputs related to contract data and the predetermined rules;
the RCRMs being configured to:
associate input data and one or more predetermined rules with one or more contracts or content owners; and
store the associated data and rules;
one or more user interfaces configured to receive and process inputs related to one or more of budgeting periods, media content, content providers, or subscribers;
a database configured to store data including the one or more RCRMs in association with data corresponding to a predetermined budgeting period;
a calculation engine for accessing the one or more RCRMs and utilizing the stored associated data and rules to determine a projected budget for a predetermined budgeting period; and
a budget output module for providing the projected budget in a predetermined output format to the budget manager personnel via the budgeting system.

2. The system of claim 1, wherein the data further includes:
a tier arrangement of content;
a content lineup arrangement;
a predetermined time period for budget computation; or
a projected number of subscribers for said tier arrangement and said content lineup during the predetermined time period for budget computation.

3. The system of claim 1 further comprising an initialization module configured to import data into the database from another system, the data being related to parameters including one or more of:
contracts,
end systems,
organizational structure,
content lineups,
budget period,
content tiers, or
number of subscribers.

4. The system of claim 1, wherein the RCRM user interface is configured to allow:
user selection by the budget manager personnel of an RCRM;
editing of particular data values of a selected RCRM; and
storing of an edited RCRM as an additional RCRM including edited data values for use in subsequent iterations of the projected budget.

5. The system of claim 4 further comprising a logging module configured to record the edits in the data.

6. The system of claim 1 further comprising a data access security module configured to define user access rights for providing system input and viewing system output.

7. The system of claim 1 further comprising an export module configured to export the output of the calculation engine.

8. The system of claim 1, wherein the calculation engine provides reports including one or more of:
budget summary report,
budget detail report,
subscriber trend report,
rate trend report,
expense trend report, or
free period provision report.

9. The system of claim 1 further comprising a closing module configured to prohibit any modification to the projected budget, once the budgeting is closed.

10. A method for providing a computer-implemented budgeting output relating to projected royalty payments due under contracts between a media system operator and content owners, comprising:
providing one or more royalty calculation rules modules (RCRMs), each RCRM including:
one or more predetermined rules for determining royalty payments;
association to one or more contract terms or content owners; and
data related to contract terms or content owners;
accepting data inputs into the one or more RCRM through an RCRM user interface;
receiving and processing inputs related to one or more of budgeting periods, media content, content providers, or subscribers through one or more user interface(s);
storing the one or more RCRMs with the associated data and the received and processed inputs into a database;
accessing the one or more RCRMs and utilizing the stored associated data and rules, along with the received and processes stored data to determine a projected budget for a predetermined budgeting period; and
providing the projected budget in a predetermined output format to the budget manager personnel via the budgeting system.

11. The method of claim 10 further comprising importing data into the database from another system, the data being related to parameters including one or more of:
contracts,
end systems,
organizational structure,
content lineups,
budget period,
content tiers, or
number of subscribers.

12. The method of claim 10 further comprising the steps of:
selection of an RCRM by the budget manager personnel;
editing particular data values of a selected RCRM; and
storing an edited RCRM as an additional RCRM including edited data values for use in subsequent iterations of the projected budget.

13. The method of claim 12 further comprising recording the edits in the data.

14. The method of claim 10, wherein the database further includes information related to one or more of:
tier arrangement of content;
content lineup arrangement;
predetermined time period for budget computation; or
projected number of subscribers for said tier arrangement and said content lineup during the predetermined time period for budget computation.

15. The method of claim 10 further comprising defining user access rights for providing input and viewing the projected budget.

16. The method of claim 10 further comprising exporting information related to the projected budget.

17. The method of claim 10 further comprising providing reports including one or more of:
budget summary report,
budget detail report,
subscriber trend report,
rate trend report,
expense trend report, or
free period provision report.

18. The method of claim 10 further comprising prohibiting any modification to the projected budget, once the budgeting is closed.

19. A method for projecting royalty payments due under contracts between a media system operator and content owners, the method comprising:
configuring a computer-implemented budgeting system with contract information regarding existing contracts between the media system operator and the content owners;
providing one or more royalty calculation rules modules (RCRMs), each RCRM including one or more predetermined rules for determining royalty payments;
an RCRM user interface configured to accept entry of inputs related to contract data and the predetermined rules,
accepting user inputs relating to contract data or predetermined rules;
associating the user inputs with predetermined rules within the contracts;
generating a budget reflecting projected royalty payments under the contract, based on the associated predetermined rules and contract data;
editing particular data values related to one or more RCRMs, upon a determination that a revised budget is required;
repeating the accessing step; and
providing a revised projected budget in a predetermined output format to the budget manager personnel via the budgeting system.

20. The business method of claim 19, wherein the editing step further comprises one or more of:
adding a newly selected RCRM and adding data values to the newly selected RCRM;
producing a copy of the RCRM and editing data values in the copy of the RCRM; or
updating the RCRM data values utilized in the generation of the projected budget.
